(19) United States
(12) Patent Application Publication
(10) Pub. No.: US 2014/0151975 A1
(43) Pub. Date: Jun. 5, 2014

(54) METHOD OF MANUFACTURING A GROUP OF BICYCLES

(71) Applicant: Specialized Bicycle Components, Inc., Morgan Hill, CA (US)

(72) Inventor: Christopher P. D'Aluisio, Corralitos, CA (US)

(73) Assignee: Specialized Bicycle Components, Inc., Morgan Hill, CA (US)

(21) Appl. No.: 14/152,510

(22) Filed: Jan. 10, 2014

Related U.S. Application Data
(62) Division of application No. 13/399,696, filed on Feb. 17, 2012.

(51) Int. Cl. B62K 3/02

(52) U.S. Cl. CPC B62K 3/02
USPC 280/279

(57) ABSTRACT

A method of designing and manufacturing a model of bicycles in such a manner that the size (e.g., diameter) of the head tube bearings and/or the stiffness of the forks varies between frame sizes. The method includes selecting first and lower headset bearing sizes for the first and second frame sizes, respectively, wherein the first lower headset bearing size is different than the second lower headset bearing size. The method further includes manufacturing first bicycles of the first frame size and second bicycles of the second frame size, and coupling first and second lower headset bearings to the first and second bicycles, respectively. The same model designations are then attached to each of the first and second bicycles. This same method can also be used with models having more than two frame sizes. The difference in size of the lower headset bearings and/or fork steerer tubes can be substantially proportional to the difference in length of the seat tube.

### CROSS-REFERENCE TO RELATED APPLICATIONS

This application is a divisional of co-pending U.S. patent application Ser. No. 13/399,696 filed on Feb. 17, 2012, the entire content of which is incorporated herein by reference.

### BACKGROUND

The present invention relates to the design and manufacture of bicycles, and particularly to the specification of lower headset bearings for a group of bicycles of different sizes and the same model.

Bicycles commonly have a frame comprising a main frame and a rear triangle. The main frame is typically made from a top tube, a head tube, a down tube, and a seat tube, and the rear triangle is typically made from two chainstays and two seatstays. A front fork is commonly rotationally mounted in the head tube and is secured to handlebars for steering the bicycle. The frame and fork assembly is supported on a front wheel rotationally secured to the fork and a rear wheel rotationally secured to the rear triangle.

Bicycles are commonly manufactured and sold in different models. A model of bicycle will commonly be offered in multiple frame sizes (e.g., having different tube lengths) from which to choose, in order to accommodate riders of different sizes. Notwithstanding these different frame sizes, bicycles within a given model typically include many things in common with each other, such as color choice, frame material, tube shapes, types of components, bearing sizes, and front fork. That is, bicycles within a given model (i.e., in a given model year) typically have these characteristics in common. For example, while the 2012 Roubaix SL3 model sold by Specialized Bicycle Components of Morgan Hill California is offered in multiple sizes, all of the bicycles in that model include the same color choice, carbon frame material, aero tube shapes, Shimano drivetrain components (e.g., front and rear derailleurs, shift levers, chain, and cassette), head tube bearings, and carbon front fork. The fork is substantially identical for all sizes, except the steerer tube is cut to different lengths to accommodate the different head tube lengths.

### SUMMARY

The present invention provides a method of designing and manufacturing a model of bicycles in such a manner that the size (e.g., diameter) of the head tube bearings varies between frame sizes. More specifically, the present invention provides a method for designing and manufacturing a model of bicycles having at least first and second frame sizes for the model. The method includes selecting a first lower headset bearing size for the first frame size and a second lower headset bearing size for the second frame size, wherein the first lower headset bearing size is different than the second lower headset bearing size. The method further includes manufacturing first bicycles of the first frame size and second bicycles of the second frame size, and coupling first lower headset bearings to the first bicycles and second lower headset bearings to the second bicycles. The same model designations are then attached to each of the first and second bicycles.

In one embodiment, the method is applied to a model of bicycles having more than two frame sizes for the model, each frame size having a different size. In this embodiment, the step of selecting further includes selecting a third lower headset bearing size for a third frame size, the third lower headset bearing size being different than the first and second lower headset bearing sizes. In addition, the step of manufacturing includes manufacturing third bicycles of the third frame size, and the step of coupling includes coupling third lower headset bearings to the third bicycles. The step of attaching includes attaching the same model designation to each of the first, second, and third bicycles. If desired, the model can include additional frame sizes, and one of the lower headset bearing sizes can be used on at least two different frame sizes.

In order to choose some of the bearing sizes, the method can further include the step of choosing a first dimension (e.g., seat tube length) for the first frame size and a second dimension (e.g., seat tube length) for the second frame size, the first dimension being different than the second dimension. In addition, the step of selecting the second lower headset bearing size can include determining a desired second lower headset bearing size by comparing the second dimension to the first dimension. In one embodiment, the step of comparing includes calculating a ratio of the second dimension to the first dimension, and multiplying the first lower headset bearing size by the ratio. After the calculation, the step of selecting the second lower headset bearing size can further include choosing a standard lower headset bearing size that is closest to the desired second lower headset bearing size.

The above method can be used to produce a group of bicycles comprising a first bicycle having a first frame size and a second bicycle having a second frame size, wherein both of the first and second bicycles corresponds with a model. The first bicycle has a first frame, a first fork, and a first lower headset bearing rotationally supporting the first fork in the first frame, and the second bicycle has a second frame, a second fork, and a second lower headset bearing rotationally supporting the second fork in the second frame. The second lower headset bearing has a second bearing size different than the first bearing size.

The group of bicycles can also include a third bicycle having a third frame size different from the first and second frame sizes and corresponding with the same model. The third bicycle has third lower headset bearing with a third bearing size different than the first and second bearing sizes.

The group of bicycles can also include a fourth bicycle having a fourth frame size different from the other frame sizes, and having a fourth bearing size that is the same as the first bearing size. Similarly, the group of bicycles can also includes a fifth bicycle having a fifth frame size different from the other frame sizes, but having a fifth bearing size that is the same as the second bearing size. In addition, the group of bicycles can also include a sixth bicycle having a sixth frame size different from the other frame sizes, but having a sixth bearing size that is the same as the third bearing size. In this manner, each of the three different bearing sizes is used on at least two different frame sizes.

The present invention can be embodied in a method for designing and manufacturing a model of bicycles, wherein the stiffness of the fork is adjusted between frame sizes. More specifically, the method can include the steps of designating first and second frame sizes for the model, selecting first forks for the first frame size and second forks for the second frame size (e.g., wherein the first forks have a different stiffness than the second forks), manufacturing first bicycles of the first frame size and second bicycles of the second frame size, attaching the same model designation to each of the first and second bicycles, and coupling the first forks to the first bicycles and the second forks to the second bicycles. In one embodiment, the first forks have a first steerer tube dimension (e.g., diameter of a lower portion of the steerer tube) and the second forks have a second steerer tube dimension (e.g., diameter of a lower portion of the steerer tube) larger than the first steerer tube dimension. Preferably, the first steerer tube dimension is at least 5% less (more preferably at least 8% less) than the second steerer tube dimension.

Other aspects of the invention will become apparent by consideration of the detailed description and accompanying drawings.

### BRIEF DESCRIPTION OF THE DRAWINGS

FIG. 1 illustrates a group of bicycles of different sizes that fall within a common model of bicycles.

FIG. 2 is vertical section view of a head tube portion of one of the bicycles in FIG. 1.

FIG. 3 is a schematic representation of a method of designing and manufacturing a group of bicycles.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

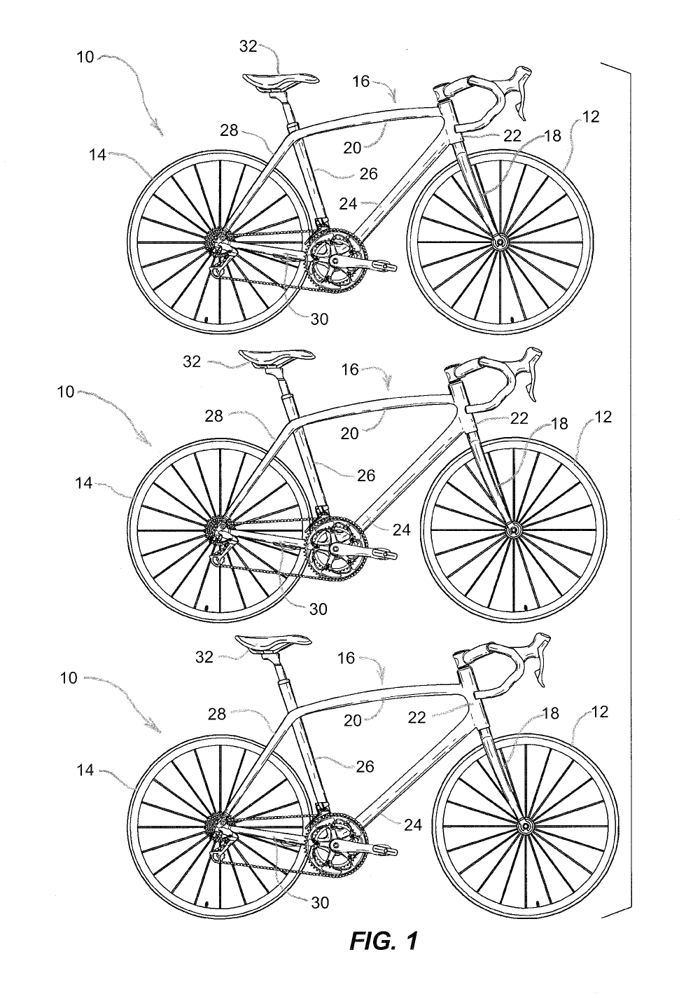

FIG. 1 illustrates a group of bicycles 10 that fall within a model. Each of the illustrated bicycles 10 includes a front wheel 12, a rear wheel 14, a frame 16, and a fork 18. Each frame 16 includes a top tube 20, a head tube 22, a down tube 24, a seat tube 26, seatstays 28, and chainstays 30. Each bicycle further includes a seat 32, a front derailleur, a rear derailleur, a drivetrain, and handlebars, as known in the art.

Each of the illustrated frames is a different size than the other frames. Specifically, each frame has certain dimensions that are different than the other frames, such as top tube length, seat tube length, and head tube length. The result is that each bicycle has a unique wheel base and stand-over height. Notwithstanding these differences in frame size, each of the illustrated bicycles has the same specification for color choice, frame material, tube shapes, and types of components (i.e., seat, front and rear derailleurs, drivetrain, brakes, handlebars, and wheels).

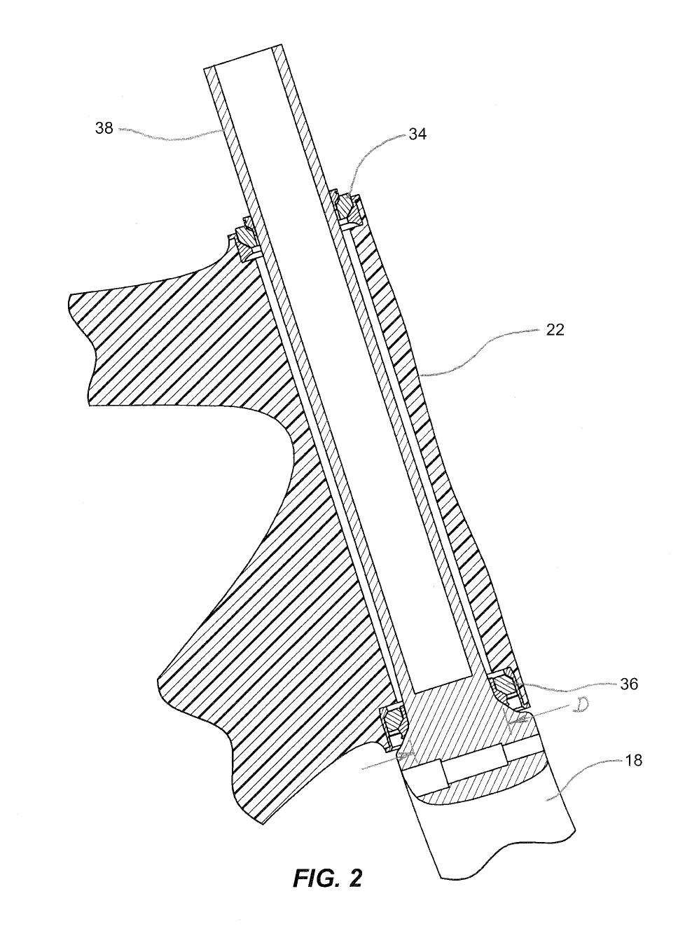

Referring to FIG. 2, each of the illustrated bicycles includes upper and lower headset bearings 34, 36 that cooperatively support the steerer tube 38 of the front fork 18 for rotation relative to the head tube 22. In order to tune the front end of the bicycle to the size of the rider, each of the three bicycles has a different fork 18 and lower headset bearing 36. More specifically, the larger bicycles are provided with a stiffer fork 18 and a larger lower headset bearing 36. As used herein, “stiffer” means that it deflects less for a given applied force.

Each lower headset bearing 36 has a diameter D (commonly designated by reference to the inner diameter of the bearing race) that is different than the diameters D of the lower headset bearings of the other illustrated bicycles. The corresponding steerer tubes 38 and head tubes 22 also have different diameters in order to accommodate the different diameters of the lower headset bearings 36. This difference in the size of the lower headset bearings 36 and fork steerer tubes 22 allows the front end of the bicycle 10 to be designed to improve the ride quality of each bicycle. Specifically, the smaller-sized bicycles are designed with a smaller-diameter lower headset bearing 36 and smaller steerer tube 22 in order to reduce the stiffness in that area and improve rider comfort, and the larger-sized bicycles are designed with a larger-diameter lower headset bearing 36 and larger steerer tube 22 in order to increase stiffness and improve ride quality. Other ways of adjusting the stiffness of the fork are also possible, such as changing the shape, material, and wall thickness of the fork.

For standardization purposes, headset bearings for bicycles, and the steerer tubes on which those bearings are mounted, are commonly provided in discrete sizes based upon the inner diameter of the bearing, which approximate the outer diameter of the fork steerer tube upon which the bearing will be mounted. Historically, lower headset bearings are most commonly provided in the following sizes (corresponding with the inner diameter of the bearing race):

1 inch (25.4 mm)

1⅛ inch (28.6 mm)

1¼ inch (31.8 mm)

1⅜ inch (34.9 mm)

1½ inch (38.1 mm)

The bicycles illustrated in FIG. 1 correspond with frame sizes that are commonly referred to as 48 cm, 56 cm, and 64 cm. These bicycles include the dimensions set forth in Table 1, below.

TABLE 1

| | 48 cm | 56 cm | 61 cm |
|---|---|---|---|
| Seat tube length | 445 mm | 515 mm | 565 mm |
| Lower headset bearing | 28.6 mm | 31.8 mm | 34.9 mm |
| size/lower steerer tube | (1⅛″) | (1¼″) | (1⅜″) |
| diameter | | | |

In designing the current model of bicycles, it was determined that the appropriate lower headset bearing for the 56 cm bicycle is 31.8 mm. In years past, the 31.8 mm lower headset bearing would have been used on all sizes within the model (with an identical fork, the only difference being the length of the steerer tube). However, with the described model embodying the present invention, the 48 cm bicycle has a 28.6 mm lower headset bearing, and the 64 cm bicycle has a 34.9 mm lower headset bearing. It is noted that the lower headset bearing size of the 48 cm bicycle is about 10% less than the lower headset bearing size of the 56 cm bicycle, and the lower headset bearing size of the 61 cm bicycle is about 10% more than the lower headset bearing size of the 56 cm bicycle.

This change in the size of the lower headset bearing can be correlated to the change in the length of the seat tube (from the center of the bottom bracket to the top of the seat tube) between the various sizes. In this example, the seat tube length of the 56 cm bicycle (“STL56”) has been chosen as the starting point or basis for the calculation. The following formula can be used in order to select a desired headset bearing size for a bicycle having a size xx and a seat tube length STLxx:

Desired Headset Bearing Size for Frame Size xx=31.8*(STLxx/STL56)

Using the numbers from the table above, as the bicycle size decreases from 56 cm to 48 cm, the seat tube length decreases from 515 mm to 445 mm, or about 14%. In order to select an appropriate lower headset bearing for the 48 cm bicycle, one can reduce the lower headset bearing size of the 56 cm bicycle (31.8 mm) by 14% and select the closest standard bearing size. In this case, for example, reducing the 31.8 mm bearing by 14% results in a desired bearing size of about 27.5 mm. The closest standard bearing size is 28.6 mm, and thus this size was chosen for the 48 cm bicycle. Similarly, as the bicycle size increases from 56 cm to 61 cm, the seat tube length increases from 515 mm to 565 mm, or about 10%. Increasing the 31.8 mm bearing size of the 56 cm bicycle by 10% results in a desired bearing size of 34.9, which is closest to the standard 34.9 mm bearing size. Of course, if the bicycle manufacturer is not concerned with using standard bearing sizes (and instead decided to make custom bearings), the chosen bearing diameter could be finely tuned to the desired size.

The above-described process can also be used to select lower headset bearing sizes for models having more than three sizes. For example, a model could offer frame sizes of 48 cm, 52 cm, 54 cm, 56 cm, 58 cm, and 61 cm. In one embodiment, these bicycles have the dimensions set forth in Table 2.

TABLE 2

| | 48 cm | 52 cm | 54 cm | 56 cm | 58 cm | 61 cm |
|---|---|---|---|---|---|---|
| Seat tube | 445 | 475 | 495 | 515 | 540 | 565 |
| length | mm | mm | mm | mm | mm | mm |
| Top tube | 518 | 537 | 548 | 565 | 582 | 600 |
| length | mm | mm | mm | mm | mm | mm |
| Head | 125 | 145 | 165 | 190 | 225 | 245 |
| tube | mm | mm | mm | mm | mm | mm |
| length | | | | | | |
| Desired | 27.5 | 29.3 | 30.6 | — | 33.3 | 34.9 |
| bearing | mm | mm | mm | | mm | mm |
| size | | | | | | |
| using ST | | | | | | |
| length | | | | | | |
| Closest | 28.6 mm | 28.6 mm | 31.8 mm | 31.8 mm | 34.9 mm | 34.9 mm |
| standard | (1-⅛″) | (1-⅛″) | (1-¼″) | (1-¼″) | (1-⅜″) | (1-⅜″) |
| bearing | | | | | | |
| size | | | | | | |

If the seat tube lengths are chosen as the bases for determining lower headset bearing size, the format and formula described above in connection with Table 1 can be used to select the desired lower headset bearing size. The results of the calculations (i.e., the desired bearing size) are set forth is Table 2. Using the calculated desired bearing size, the closest standard bearing sizes are selected.

It should be appreciated that the method set forth above provides a general guideline for selecting an appropriate lower headset bearing diameter for a given frame size within a model of bicycles. However, certain other factors might dictate that certain sizes deviate from the above calculations. For example, if the particular model is being designed for larger/heavier riders, then some or all of the bearing sizes might be increased by one size in order to accommodate the higher stresses associated with larger/heavier riders. Similarly, for smaller/lighter riders, a corresponding decrease in bearing size for some or all of the bicycle sizes might be warranted.

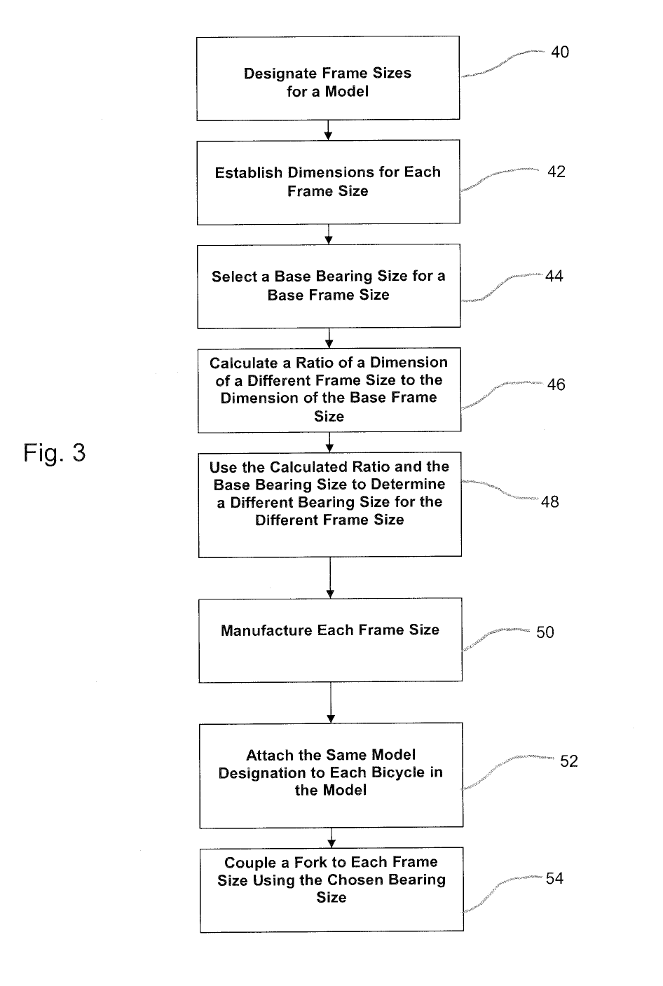

Referring to FIG. 3, a model of bicycles can be designed and manufactured according to the present invention by designating 40 multiple frame sizes for the model, and establishing 42 different dimensions for each frame size. A lower headset bearing size is then chosen for each frame size. Various ways can be used to select the correct lower headset bearing size, it being understood that smaller frames will generally have smaller lower headset bearing sizes and larger frame will generally have larger lower headset bearing sizes. For example, a base lower bearing headset size can be selected 44 for a base frame size (e.g., 56 cm), and the lower headset bearing sizes for different frame sizes can be selected based on the change in seat tube length (from the 56 cm frame to the different frame size), as described above. More specifically, one can calculate 46 a ratio of the seat tube length of the different frame size to the seat tube length of the base frame size, and then use 48 the calculated ratio and the base bearing size to determine a different bearing size for the different frame size. After all calculations are complete, the frames are then be manufactured 50, and the same model designation are attached 52 to each bicycle. For example, decals, stickers or the like having the same model designation are attached to each of the bicycles so that the bicycles can be marketed and sold under the same model. An appropriate-sized fork is then coupled 54 to each frame size using the chosen bearing size.

Various features and advantages of the invention are set forth in the following claims.

1. A group of bicycles comprising:
a first bicycle having a first frame size and corresponding with a model, the first bicycle having a first frame, a first fork, and a first lower headset bearing rotationally supporting the first fork in the first frame, the first lower headset bearing having a first bearing size; and
a second bicycle having a second frame size different from the first frame size and corresponding with the same model, the second bicycle having a second frame, a second fork, and a second lower headset bearing rotationally supporting the second fork in the second frame, the second lower headset bearing having a second bearing size different than the first bearing size.

2. A group of bicycles as claimed in claim 1, further comprising a third bicycle having a third frame size different from the first and second frame sizes and corresponding with the same model, the third bicycle having a third frame, a third fork, and a third lower headset bearing rotationally supporting the third fork in the third frame, the third lower headset bearing having a third bearing size different than the first and second bearing sizes.

3. A group of bicycles as claimed in claim 2, further comprising a fourth bicycle having a fourth frame size different from the first, second and third frame sizes and corresponding with the same model, the fourth bicycle having a fourth frame, a fourth fork, and a fourth lower headset bearing rotationally supporting the fourth fork in the fourth frame, the fourth lower headset bearing having a fourth bearing size that is the same as the first bearing size.

4. A group of bicycles as claimed in claim 3, further comprising a fifth bicycle having a fifth frame size different from the first, second, third and fourth frame sizes and corresponding with the same model, the fifth bicycle having a fifth frame, a fifth fork, and a fifth lower headset bearing rotationally supporting the fifth fork in the fifth frame, the fifth lower headset bearing having a fifth bearing size that is the same as the second bearing size.

5. A group of bicycles as claimed in claim 4, further comprising a sixth bicycle having a sixth frame size different from the first, second, third, fourth, and fifth frame sizes and corresponding with the same model, the sixth bicycle having a sixth frame, a sixth fork, and a sixth lower headset bearing rotationally supporting the sixth fork in the sixth frame, the sixth lower headset bearing having a sixth bearing size that is the same as the third bearing size.

6. A group of bicycles as claimed in claim 1, wherein the first frame has a first seat tube length and the second frame has a second seat tube length shorter than the first seat tube length, and wherein the second bearing size is less than the first bearing size.

7. A group of bicycles as claimed in claim 1, wherein the first frame has a first seat tube length and the second frame has a second seat tube length longer than the first seat tube length, and wherein the second bearing size is greater than the first bearing size.
